(19) United States
(12) Patent Application Publication
(10) Pub. No.: US 2009/0175134 A1
(43) Pub. Date: Jul. 9, 2009

(54) Alarm and managing method thereof

(75) Inventor: Wen-Tsung Yang, Taipei (TW)

Correspondence Address: REED SMITH LLP, 3110 Fairview Park Drive, Suite 1400, Falls Church, VA, 22042, US

(73) Assignee: Compal Communications, Inc.

(21) Appl. No.: 12/318,623

(22) Filed: Jan. 2, 2009

(30) Foreign Application Priority Data
Jan. 4, 2008 (TW) 097100290

(51) Int. Cl. G04C 21/00; G04B 23/02

(52) U.S. Cl. 368/73; 368/262

(57) ABSTRACT

The present invention provides a method of managing an alarm. According to the method of the invention, step (a) is firstly performed to control the alarm to ring at a predetermined time and generate a first question. Secondly, step (b) is performed to receive a first answer inputted by a user. Thirdly, step (c) is performed to judge whether the first answer matches a first default answer. If the first answer matches the first default answer, step (d) is finally performed to control the alarm to stop ringing.

### BACKGROUND OF THE INVENTION

1. Field of the Invention

The present invention relates generally to an alarm, and more particularly, to a managing method thereof.

2. Description of the Prior Art

Alarm is quite an important and common tool in our busy lives. Nowadays, many electronic devices such as radios, desk computers, or mobile communication devices (e.g. mobile phones, personal digital assistants (PDAs), or notebook computers) are designed to have an alarm function.

Generally, the main function of the alarm is to ring at users' predetermined time to remind users that time is up. For example, an alarm is usually used to wake users up in the morning, so users would not be late for work or school.

However, the efficacy of a general alarm is often not impressive. The crux of the problem is that users usually still feel sleepy while hearing the alarm ring. To avoid the alarm keeping ringing, users usually turn off the alarm unconsciously and then keep lingering in their beds. Thereby, a common alarm which rings loudly at a predetermined time may not meet the expected efficacy or may cause users to be late for work or miss an important meeting so that a significant loss is induced.

Accordingly, the main aspect of the present invention is to provide an alarm and a managing method thereof to solve the problems mentioned above.

### SUMMARY OF THE INVENTION

The main aspect of the present invention is to provide a method of managing an alarm. Different from the alarms in the prior art which simply ring a bell, the method in the present invention adopts a conception of intelligent alarm that users should clear-headedly answer the questions displayed on a screen to make the alarm stop ringing, and the expected efficacy of the alarm is thus achieved.

According to a preferred embodiment of the invention, the alarm is firstly controlled to ring at a predetermined time and to display a first question. After that, the alarm receives a first answer inputted by a user and judges whether the first answer matches a first default answer corresponding to the first question. If the first answer matches the first default answer, the alarm will stop ringing. If the first answer doesn't match the first default answer, the alarm will display a second question or repeat the first question. Therefore, the alarm can reach the expected efficacy.

According to another preferred embodiment of the present invention, the alarm comprises a voice outputting module; a display module; a controlling module which controls the voice outputting module to ring at a predetermined time and controls the voice outputting module to broadcast a first question and/or controlling the display module to display the first question; and a receiving module used for receiving a first answer inputted by a user. When the receiving module receives the first answer, the controlling module judges whether the first answer matches a first default answer corresponding to the first question, if the first answer matches the first default answer, the controlling module controls the voice outputting module to stop ringing.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 is a flow chart illustrating a method of managing an alarm according to a preferred embodiment of the invention.

FIG. 2 is a functional block illustrating an alarm according to another preferred embodiment of the invention.

FIG. 3 is a functional block illustrating the alarm in FIG. 2 further comprising a database.

### DETAILED DESCRIPTION OF THE INVENTION

The present invention provides a method of managing an alarm. According to the method of the invention, users should clear-headedly answer the questions displayed on a screen to make the alarm stop ringing. Therefore, the alarm can reach the expected efficacy.

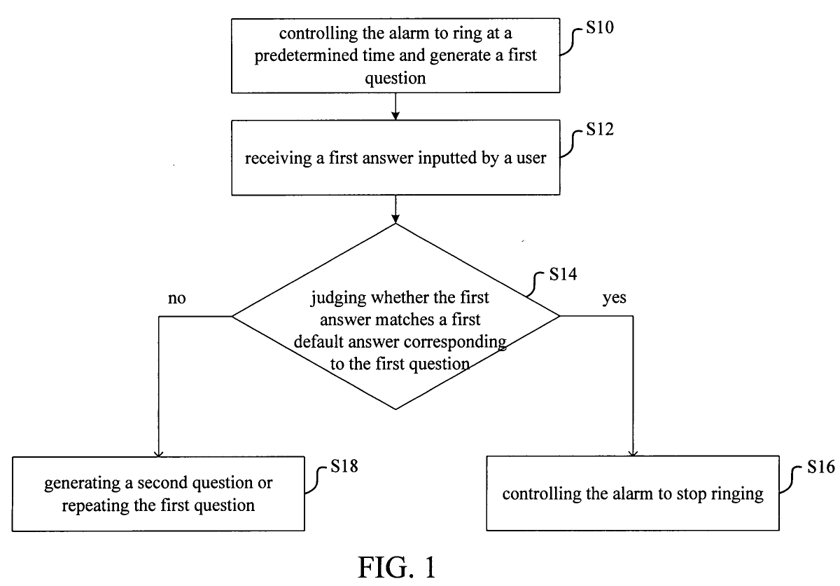

A preferred embodiment of the invention is a method of managing an alarm. Please refer to FIG. 1. FIG. 1 is a flow chart illustrating the method of managing the alarm.

As illustrated in FIG. 1, step S10 is firstly performed in the method to control the alarm to ring at a predetermined time and generate a first question. Subsequently, step S12 is performed in the method to receive a first answer inputted by a user.

After that, step S14 is performed to judge whether the first answer matches a first default answer corresponding to the first question. The following discussion is about two possible situations based on the judging result in step S14.

The first situation is that if the first answer matches a first default answer, then step S16 is performed to control the alarm to stop ringing.

The second situation is that if the first answer doesn't match the first default answer, then step S18 is performed to display a second question or repeat the first question. Therefore, the purpose of making the users be clear-headed is achieved.

In practical applications, the alarm could be built in a mobile communication device (such as a mobile phone). Moreover, the first answer could be a letter message (e.g. inputted by a keyboard) or a voice message (e.g. inputted by a microphone) based on different ways of inputting messages.

In practical applications, the alarm could further comprises a database which stores a plurality of default questions and a plurality of default answers corresponding to the plurality of default questions.

In the preferred embodiment mentioned above, the first question, the second question and the first default answer corresponding to the first question are provided by the database. For example, the default questions could comprise questions such as common senses of life, multiplication, brain twisters, etc.

Furthermore, the alarm could provide a function which enables users to make their own questions. Users could input questions designed by themselves, such as users' birthdays, users' vehicle identification numbers, users' mobile phone numbers, etc. More particularly, the first question or the second question could be designed as a short-answer-test, multi-choice-test, yes-no-test, or other forms of test.

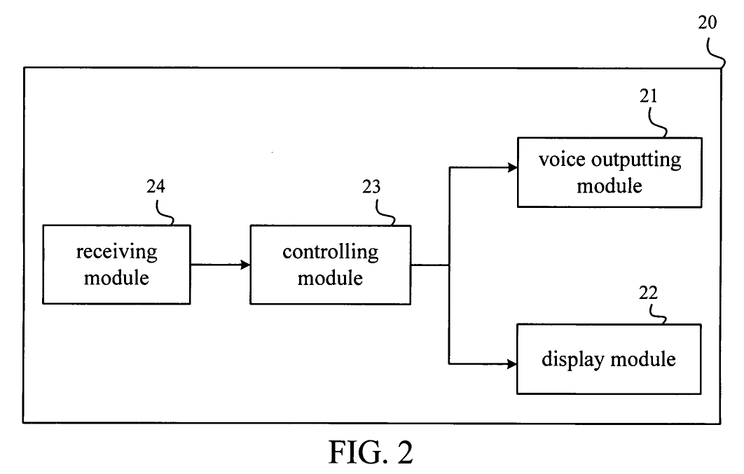

Another preferred embodiment of the invention is an alarm. Please refer to FIG. 2. FIG. 2 is a functional block illustrating the alarm.

As illustrated in FIG. 2, the alarm 20 comprises a voice outputting module 21, a display module 22, a controlling module 23 and a receiving module 24.

The controlling module 23 is for controlling the voice outputting module 21 to ring at a predetermined time and controlling the voice outputting module 21 to broadcast a first question and/or controlling the display module 22 to display the first question.

The receiving module 24 is for receiving a first answer inputted by a user. When the receiving module 24 receives the first answer, the controlling module 23 judges whether the first answer matches a first default answer corresponding to the first question. The following discussion is about two possible judging results judged by the controlling module 23.

The first possible result is that if the first answer matches the first default answer corresponding to the first question (because users have answered the first question accurately), the controlling module 23 controls the voice outputting module 21 to stop ringing.

The second possible result is that if the first answer doesn't match the first default answer corresponding to the first question (namely, users have not answered the first question accurately), the controlling module 23 controls the voice outputting module 21 to broadcast a second question and/or controls the display module 22 to display the second question or repeat the first question, for giving users an opportunity of answering questions again.

In practical applications, the alarm could be built in a mobile communication device (such as a mobile phone). Moreover, the first answer could be a letter message (e.g. inputted by a keyboard) or a voice message (e.g. inputted by a microphone) based on different ways of inputting messages.

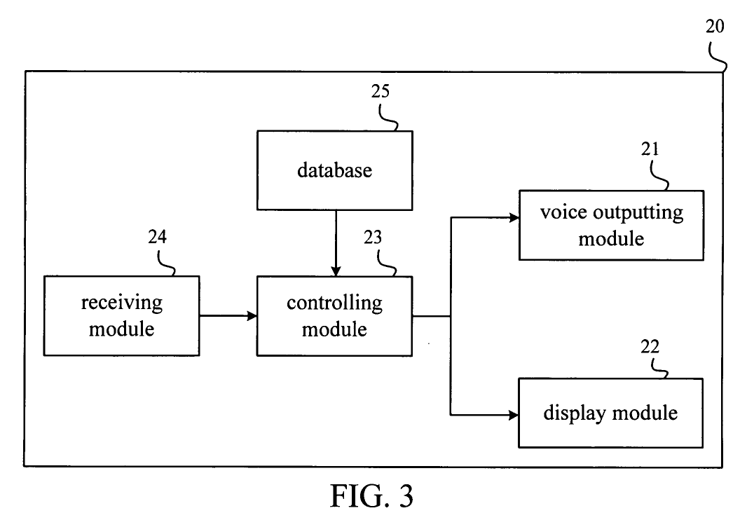

As illustrated in FIG. 3, the alarm 20 could further comprises a database 25 which stores a plurality of default questions and a plurality of default answers corresponding to the plurality of default questions. Namely, the database 25 is an item bank.

The controlling module 23 could retrieve the first question, the second question and the first default answer corresponding to the first question from the database 25. In practical applications, when the first answer doesn't match the first default answer corresponding to the first question, the alarm 20 could control the voice outputting module 21 to broadcast the first default answer corresponding to the first question retrieved from the database 25. By doing so, the correct answer of the first question can be provided to users.

Please refer to FIG. 3. In an embodiment of the invention, the alarm 20 could be designed, especially for those users who like lingering in their beds, to ring at a predetermined time and generates a plurality of questions simultaneously.

For example, after users accurately answer a first question, the alarm 20 controls the voice outputting module 21 to broadcast a second question immediately. In the embodiment, the voice outputting module 21 stops ringing only when users have accurately answered the first question and the second question.

In another embodiment, the alarm 20 of the invention is designed to control the voice outputting module 21 to stop ringing after users accurately answer the first question. However, after a predetermined period, the alarm 20 will generate a second question to avoid users unconsciously answering the first question and then continuously lingering in their beds.

Particularly, the predetermined period mentioned above could be fixed. For example, one question is generated for every ten minutes. Or, it can be progressive such as shortening the period from ten minutes to five minutes, two minutes or even a shorter one. By means of generating questions more and more frequently, the alarm 20 could avoid users continuously lingering in their beds.

Compared to the alarms in the prior art which simply ring a bell, the method of managing an alarm according to the present invention adopts a conception of intelligent alarm. Users should clearheadedly answer the questions displayed on a screen to make the alarm stop ringing, so the expected efficacy of the alarm is achieved.

Moreover, the alarm could be built in a mobile communication device. More particularly, the mobile communication device could reach the expectation without any extra devices and extra cost.

Furthermore, the database of the alarm could store a great quantity of items of various subjects, which not only interests users but also broadens users' knowledge.

Although the present invention has been illustrated and described with reference to the preferred embodiment thereof, it should be understood that it is in no way limited to the details of such embodiment but is capable of numerous modifications within the scope of the appended claims.

What is claimed is:

1. A method of managing an alarm comprising the following steps:
(a) controlling the alarm to ring at a predetermined time and generating a first question;
(b) receiving a first answer inputted by a user;
(c) judging whether the first answer matches a first default answer corresponding to the first question; and
(d) if the result of step (c) is yes, controlling the alarm to stop ringing.

2. The method of claim 1, wherein the alarm is built in a mobile communication device.

3. The method of claim 1 further comprising the following step:
(e) if the result of step (c) is no, generating a second question.

4. The method of claim 1 further comprising the following step:
(e′) if the result of step (c) is no, repeating the first question.

5. The method of claim 1, wherein the first answer is a letter message or a voice message.

6. The method of claim 1, wherein the alarm comprises a database which stores a plurality of default questions and a plurality of default answers corresponding to the plurality of default questions, and step (a) is to retrieve the first question from the database, and step (c) is to retrieve the first default answer corresponding to the first question from the database.

7. The method of claim 6 further comprising the following steps:
(e″) if the result of step (c) is no, broadcasting the first default answer corresponding to the first question retrieved from the database.

8. An alarm comprising:
a voice outputting module;
a display module;
a controlling module for controlling the voice outputting module to ring at a predetermined time and controlling the voice outputting module to broadcast a first question and/or controlling the display module to display the first question; and
a receiving module for receiving a first answer inputted by a user;
wherein when the receiving module receives the first answer, the controlling module judges whether the first answer matches a first default answer corresponding to the first question, and if the first answer matches the first default answer, the controlling module controls the voice outputting module to stop ringing.

9. The alarm of claim 8, wherein the alarm is built in a mobile communication device.

10. The alarm of claim 8, wherein if the first answer doesn't match the first default answer, the controlling module controls the voice outputting module to broadcast a second question and/or controls the display module to display the second question.

11. The alarm of claim 8, wherein if the first answer doesn't match the first default answer, the controlling module controls the alarm to repeat the first question.

12. The alarm of claim 8, wherein the first answer is a letter message or a voice message.

13. The alarm of claim 10 further comprising:
a database for storing a plurality of default questions and a plurality of default answers corresponding to the plurality of default questions, and the controlling module retrieving the first question, the second question and the first default answer corresponding to the first question from the database.
